(19) United States
(12) Patent Application Publication
(10) Pub. No.: US 2008/0147372 A1
(43) Pub. Date: Jun. 19, 2008

(54) AUTOMATIC METHOD AND SYSTEM FOR IDENTIFYING AND RECORDING TRANSACTION DATA GENERATED FROM A COMPUTER SIMULATION OF AN INTEGRATED CIRCUIT

(75) Inventor: William R. PAULSEN, Lutherville, MD (US)

Correspondence Address: MCDERMOTT WILL & EMERY LLP, 18191 VON KARMAN AVE., SUITE 500, IRVINE, CA, 92612-7108, US

(73) Assignee: Cadence Design Systems, Inc., San Jose, CA (US)

(21) Appl. No.: 11/610,828

(22) Filed: Dec. 14, 2006

(51) Int. Cl. G06F 17/50

(52) U.S. Cl. 703/14

(57) ABSTRACT

An automated method and system for managing simulation results of a virtual circuit. Data related to the virtual circuit is accessed. The virtual circuit is subject to a simulation. An initiation of each of one or more transactions occurred during the simulation is identified, and data related to the one or more transactions during the simulation is collected. Upon receipt of a user request, the collected data related to the one or more transactions is output, displayed, stored or made available for review or further processing.

### FIELD OF THE DISCLOSURE

This application relates generally to providing an automatic environment for the simulation and/or functional verification of electronic circuit designs, and more specifically, to automatically identifying and/or recording data related to transactions in a circuit simulation, with none or little user intervention.

### BACKGROUND

An integrated circuit (IC) may include millions of individual devices, such as transistors, capacitors, and resistors, for performing desired functions. Production and design of ICs is an intricate process that involves many steps. One step in IC designs involves designing a virtual version of the IC using computer-aided design tools. The design of a virtual version of an IC can be broken down into three general areas: design definition, design verification, and design layout. IC design definition can be described at various levels of sophistication or detail. The levels of design sophistication include the functional level, also referred to as the register transfer level (RTL) or the architectural level; the logical level, also referred to as the gate level; and the transistor level, also referred to as the layout level. Hardware design languages (HDL), such as Verilog, VHDL, System C, etc., are commonly used at the functional design level.

In order to minimize the cost of design errors, the functional design of an IC is put through a verification process to identify and correct functional design problems before the IC is laid out and fabricated. An example of design verification involves performing a computer simulation of a virtual design of the IC and applying a known series of input data, also known as verification vectors, to the inputs of the IC, and the corresponding output of the IC are obtained and verified. The design is verified by a design engineer by studying the simulated outputs of the IC to determine if the IC is functioning correctly.

The design simulation at the functional level requires a large volume of verification vectors. As the complexity of an IC grows, the volume of verification vectors grows exponentially in relation to the number of gates in the IC. This large volume of verification vectors is difficult to manage.

One technique, known as transaction recording, is used to allow abstraction of lower level activity in a design to higher levels, such that a design can be more easily evaluated. A transaction is defined as a specific sequence of transitions on a selection or grouping of signals over a period of time where the signal activity has some higher level operational meaning. For example, a transaction may be comprised of a single operation such as a read operation, a write operation, or some other kind of finite operation that is carried out as part of a testbench through multiple pin connections. Transaction-related data allows a designer to observe results at the level at which the design was conceived instead of at the level of individual signals. For example, it is easier to think about memory read/write transactions than about the values on the enable, address, and data signals.

Simulation results may be recorded on a transaction basis by storing standard simulation results along with transaction-specific data elements, including the name of the transaction, the start time of the transaction, the end time of the transaction and a stream, which is a data repository for transaction-related data, corresponding to the transaction. Additional transaction-specific data elements may include parent and child relationships and predecessor and successor relationships between transactions. In addition to recording simulation results on a transaction basis, simulation results are also graphically displayed on a transaction basis in a manner that allows for quicker and more intuitive analysis and debugging of simulation results.

However, this approach requires users or circuit designers to explicitly add additional code or statements to their HDL designs to enable transaction recording. The additional code or statements give instructions to the simulator to begin or end transactions, to set the transaction names, data values associated with the transaction, and any relation links with other transactions. Users must also manage references to their transactions, so they can be referred to by other transactions.

As the additional code or statements for gathering transaction-related data requires additional work and time, designers are often hesitant to take the time for this activity. Further tasks are required as designers must also manage the additional transaction recording statements and the transaction streams on which similar transactions are recorded. Furthermore, the additional statements or code also clutter the HDL code and affect the efficiency of simulation.

Therefore, there is a need for an effective and automatic approach for detecting and recording transaction-related data with none or limited user intervention.

### SUMMARY OF THE DISCLOSURE

This disclosure describes various embodiments for automatically identifying and recording data related to transactions occurred during a simulation of a circuit design, with none or limited user intervention. The recorded data is provided, output or made available to a user, such as by displaying the data or storing the data for access by a user. Users do not need to add additional code to descriptions of circuit designs to enable transaction recording. In one embodiment, users have access to descriptions of the circuit design relating to each identified transaction. Embodiments of this disclosure improve designer productivity by eliminating the need to explicitly add statements or code that is needed to provide external access to higher level design activities.

An exemplary method of this disclosure manages simulation results of a virtual circuit. Data related to the virtual circuit is accessed. The virtual circuit is subject to a simulation according to simulation code. An initiation of each of one or more transactions occurred during the simulation is identified, and data related to the one or more transactions during the simulation is collected. The collected data related to the one or more transactions is provided, either automatically or upon receiving a request from a user. In one aspect, the data related to the identified transaction may include at least one of a name of each of the one or more transactions, a start time of each of the one or more transactions, an end time or duration of each of the one or more transactions, a stream, which is a data repository for transaction-related data, corresponding to each of the one or more transactions takes place, names of variables associated with each of the one or more transactions, error information associated with each of the one or more transactions, a transaction causing the initiation of each of the one or more transactions, and variable values for each named variable associated with each of the one or more transactions.

According to one embodiment, the termination of each of the one or more transactions is identified and the data related thereto is recorded. According to another embodiment, the exemplary method graphically displays a result of the simulation and the data related to each of the one or more transactions in a way that distinct transactions are visually distinguishable. In still another embodiment, a visual indication is displayed indicating that detailed information related to the one or more transactions is available. In another embodiment, data related to each of the one or more transactions is displayed relative to a time axis. According still another embodiment, portions of the description data or the simulation code associated with a selected one of the one or more transactions or any transaction causing the initiation of the selected one of the one or more transactions is identified.

The concepts and acts described in this disclosure may be embodied in a data processing system or in a machine-readable medium carrying instructions which, upon execution by a data processing system, control the data processing system to perform the acts described in this disclosure.

Additional aspects and advantages of the present disclosure will become readily apparent to those skilled in this art from the following detailed description, wherein only exemplary embodiments of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 is a block diagram of an exemplary simulation system according to this disclosure.

FIG. 2 is a flow chart showing the operation of an exemplary simulation system in identifying transactions and recording data related to transactions.

FIG. 3 shows exemplary HDL code including a subprogram or a data object and corresponding data recorded by a simulation system according to this disclosure.

FIG. 4 is a block diagram of an exemplary data processing system upon which a simulation system according to this disclosure may be implemented.

### DETAILED DESCRIPTION OF THE DISCLOSURE

In the following description, for the purposes of explanation, numerous specific details are set forth in order to provide a thorough understanding of the present disclosure. It will be apparent, however, to one skilled in the art that the present disclosure may be practiced without these specific details. In other instances, well-known structures and devices are shown in block diagram form in order to avoid unnecessarily obscuring the present disclosure.

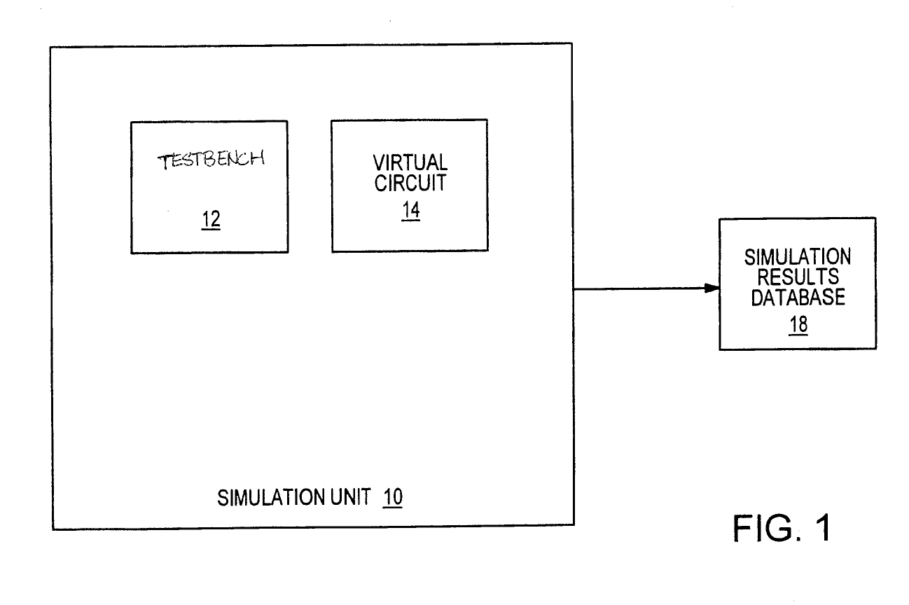

FIG. 1 is a block diagram of an exemplary simulation system 10 according to this disclosure for simulating the operations of a virtual IC 14. The exemplary simulation system 10 permits HDL transaction information to be automatically identified, for analysis or for recording into a transaction recording database. Users do not need to add additional code to their HDL designs to enable transaction recording.

The simulation system 10 executes simulation code to perform a simulation of the virtual IC 14. The simulation code includes a compilation of verification vectors, such as a testbench 12, to verify or examine the operations of the virtual IC 14 designed by using description data, such as hardware description language (HDL). The testbench 12 is a software representation of an interface to the virtual IC 14 and interacts with the virtual IC 14 during a simulation by sending data to, and receiving data from, the virtual IC 14 during the simulation. Testbenches may send a large body of defined data to the virtual IC 14 or may verify whether data is received in a fashion that conforms to the specification of how an interface is supposed to operate.

During a simulation process, the simulation system 10 generates simulation results over the course of the simulation according to the operations of the testbench 12 and the virtual IC 14. The simulation results are stored in a simulation results database 18 for future use. The simulation results typically flow from the simulation system 10 in a stream of data and then are stored in the database.

During a simulation operation, there are many suboperations that occur during the operation of the testbench 12 or the virtual circuit 14. The suboperations are performed by calling an HDL subprogram or an HDL data object. It is understood to people skilled in the art that both subprograms and data objects are useable in software coding to simplify the coding process. In the following descriptions, the terms subprogram and data object are used interchangeably. When an HDL subprogram is called or a data object is created, the simulation system 10 determines that a new transaction is started or initiated on the transaction stream of the HDL data object that is calling the subprogram or that is creating the data object. The simulation system 10 automatically records the input and in/out arguments of the subprogram or data object as attributes of each transaction. When the subprogram returns or data object is deleted, the output and in/out arguments of the subprogram or variables of the data object are recorded, and the simulation system 10 determines that the transaction is ended or terminated. If a subprogram or data object further calls any subprograms or creates any data objects, then the simulation system 10 identifies initiations of additional transactions based on the calls of those additional subprograms or new data objects. Data related to the transactions are likewise recorded. In one embodiment, a relation link is established between the caller and called subprogram, or with the newly created data object. Data related to the associated transactions and the relation link is recorded.

An HDL subprogram or data object can be a user-written subprogram or data object in the HDL, a user-written foreign subprogram or data object, a subprogram or data object that is built-in to HDL, one of a pre-established subprogram or data object library, or any other compilations of instructions or machine-readable commands which, upon execution by a data processing system, such as a computer, and being called by a software object, perform a specific function or task according to the contents of the subprogram or data object.

A transaction stream is a repository for transactions. Each HDL data object, whether statically or dynamically created, is automatically associated with a stream. As each dynamic HDL data object is created during simulation, a new transaction is started on its associated stream. The simulation system 10 sets a relational link between the object and the parent of the object. Members of the object that have initial values are automatically recorded as attributes in the transaction. As object members' values are set as simulation progresses, the simulation system 10 records these values as attributes of the transaction. When the object is deleted, the simulation system 10 determines that the transaction is ended.

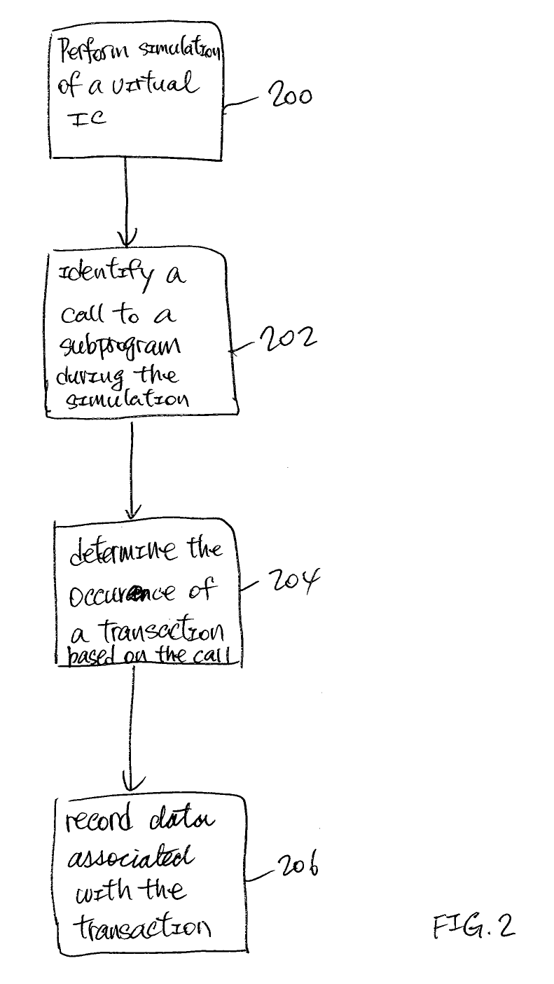

FIG. 2 is a flow chart showing the operation of the simulation system 10 in identifying transactions and recording data related to the transactions. In Block 200, the simulation system 10 performs a simulation of the virtual IC 14 by executing simulation code. In Block 202, the simulation system monitors the execution of the simulation and identifies a call to a subprogram or creation of a data object during the simulation. In Block 204, the simulation system 10 determines the occurrence of a transaction based on the identified call to the subprogram or creation of the data object. In Block 206, the simulation system 10 records data related to the transaction. Exemplary data recorded by the simulation system 10 includes at least one of a name of each of the one or more transactions, a start time of each of the one or more transactions, an end time or duration of each of the one or more transactions, a stream on which each of the one or more transactions takes place, names of variables associated with each of the one or more transactions, error information associated with each of the one or more transactions, variable values for each named variable associated with each of the one or more transactions, identification information allowing identification of the locations in the source HDL code which caused the transaction to be recorded, names of transactions, such as deriving from the name of the data object or subprogram, etc. In one embodiment, the simulation results and data related to the identified transactions are graphically displayed to enable simulation analysis and debugging.

In one embodiment, the simulation system 10 identifies and records data related to specific portions of the HDL code of the virtual circuit 14 or the simulation code that calls a subprogram or creates a data object. This recorded data allows users to have explicit access from their HDL code to the automatically generated transactions. Such access includes new HDL syntax or subprogram or data objects for obtaining a reference handle to the transactions, and to the transaction stream of an object. This access to the automatic recording is useful in several ways, including appending further information to a transaction or stream, such as an abnormal or erroneous condition; enabling/disabling transaction data recording; creating additional transactions or streams, etc.

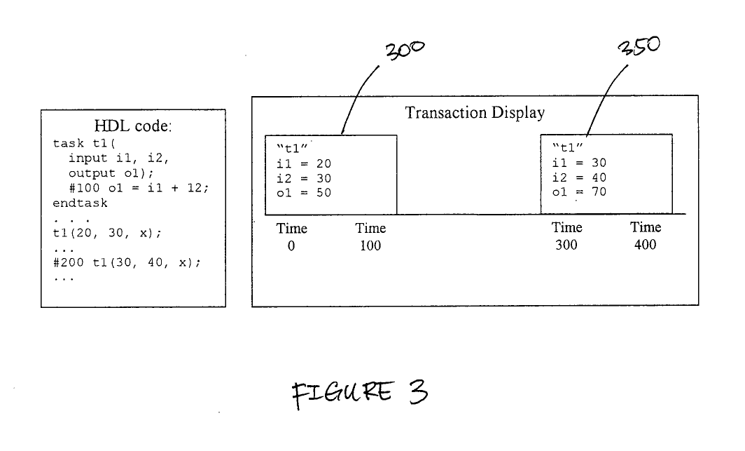

FIG. 3 shows exemplary HDL code including a subprogram t1 being called twice. Subprogram t1 includes input arguments i1 and i2, and provides a time delay of 100 simulation time units and an output argument o1 that is set to i1+i2 (01=i1+i2). During a simulation according to the exemplary HDL code, subprogram t1 is called for the first time as t1 (20, 30, x), and for the second time as t1 (30, 40, x) after a delay of 200 simulation time units. The simulation system 10 identifies the initiation of a first transaction 300 associated with the first call to subprogram t1 based on the first call to subprogram t1, and determines the termination of the transaction 300 according to the first return of the subprogram t1 based on the endtask command in subprogram t1. Similarly, the simulation system 10 identifies the initiation of a second transaction 350 according to the second call to the subprogram t1, and the termination of the second transaction 350 based on the conclusion of the second call to the subprogram t1. As shown in FIG. 3, the simulation system records data related to the transactions 300 and 350. The recorded data includes the inputs, outputs, starting times and ending times, and durations of the identified transactions. In one embodiment, the recorded data related to the transactions is displayed relative to a reference time axis, to assist users performing analysis and debugging. The display is automatically performed after each simulation or upon receiving a request from a user.

In another embodiment, an exemplary simulation system according to this disclosure automatically identifies transactions according to specific syntactic patterns in HDL code, or certain sequences of HDL code executions. A look-up table identifying specific patterns or sequences is created in advance and stored in a data storage device accessible by an exemplary simulation system according to this disclosure. During a simulation process, the execution of simulation code and/or circuit designs in HDL language are closely monitored and compared with information in the pre-stored table. Once a match occurs, the simulation system determines that a transaction has occurred and data associated with the transaction is recorded.

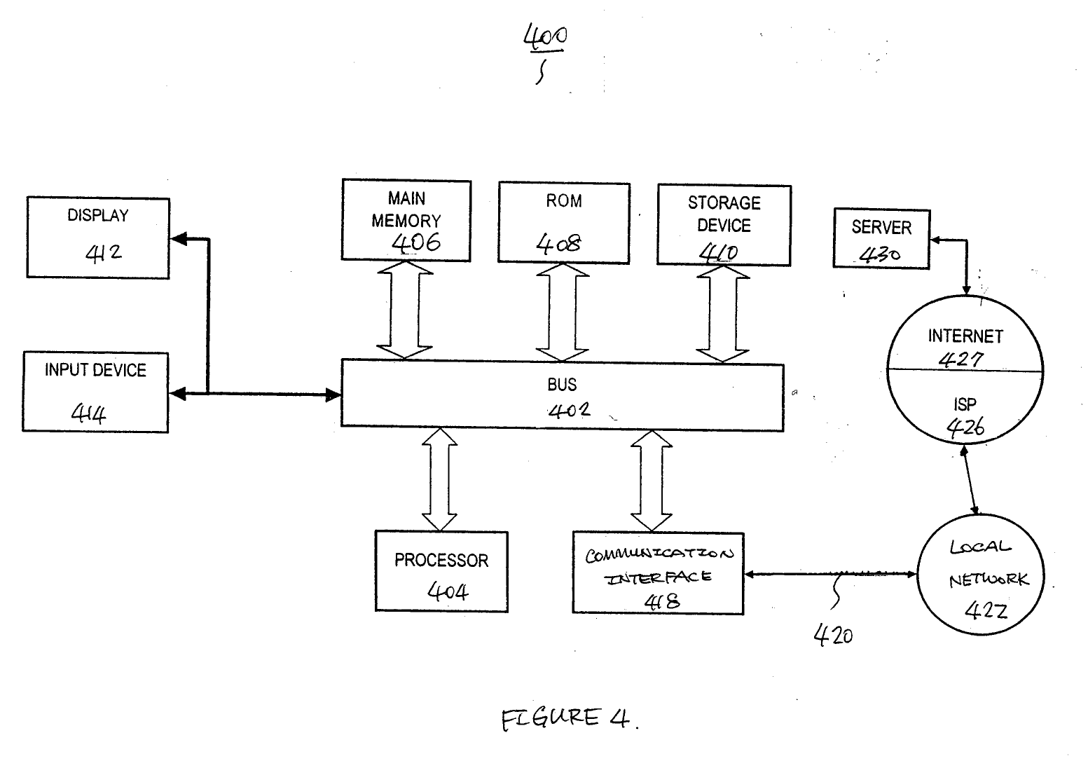

FIG. 4 shows a block diagram of an exemplary data processing system upon which the above-described techniques, methods, concepts and embodiments can be implemented. The data processing system 400 includes a bus 402 or other communication mechanism for communicating information, and a data processor 404 coupled with bus 402 for processing data. Data processing system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by data processor 404. Data processing system 400 further includes a read only memory (ROM) 408 or other static storage device coupled to bus 402 for storing static information and instructions for processor 404. A storage device 410, such as a magnetic disk or optical disk, is provided and coupled to bus 802 for storing information and instructions.

The data processing system 400 may be coupled via bus 402 to a display 412, such as a cathode ray tube (CRT) or liquid crystal display (LCD), for displaying information to an operator. An input device 414, including alphanumeric and other keys, is coupled to bus 402 for communicating information and command selections to processor 404. Another type of user input device is cursor control 416, such as a mouse, a trackball, or cursor direction keys and the like for communicating direction information and command selections to processor 804 and for controlling cursor movement on display 412.

The data processing system 400 is controlled in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the processes described herein. In alternative embodiments, hard-wired circuitry may be used in place of or in combination with software instructions to implement the disclosure. Thus, embodiments of the disclosure are not limited to any specific combination of hardware circuitry and software. The above-described techniques, methods, concepts and embodiments are implemented as instructions or software embedded in machine-readable medium which, upon execution by the data processing system, control the data processing system perform the intended process as specified in the instructions.

The term “machine readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio wave and infrared data communications.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 404 for execution. For example, the instructions may initially be carried on a magnetic disk of a remote data processing system, such as a server. The remote data processing system can load the instructions into its dynamic memory and send the instructions over a telephone line using a modem. A modem local to data processing system 400 can receive the data on the telephone line and use an infrared transmitter to convert the data to an infrared signal. An infrared detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Data processing system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host data processing system or to data equipment operated by an Internet Service Provider (ISP) 426. ISP 426 in turn provides data communication services through the world large packet data communication network now commonly referred to as the Internet 427. Local network 422 and Internet 427 both use electrical, electromagnetic or optical signals that carry digital data streams. The signals through the various networks and the signals on network link 420 and through communication interface 418, which carry the digital data to and from data processing system 400, are exemplary forms of carrier waves transporting the information.

Data processing system 400 can send messages and receive data, including program code, through the network(s), network link 420 and communication interface 418. In the Internet example, a server 430 might transmit a requested code for an application program through Internet 427, ISP 426, local network 422 and communication interface 418.

The data processing system 400 also has various signal input/output ports (not shown in the drawing) for connecting to and communicating with peripheral devices, such as USB port, PS/2 port, serial port, parallel port, IEEE-1394 port, infra red communication port, etc., or other proprietary ports. The data processing system 400 may communicate with the data processing system via such signal input/output ports.

The disclosure has been described with reference to specific embodiments thereof. It will, however, be evident that various modifications and changes may be made thereto without departing from the broader spirit and scope of the disclosure. The concepts described in the disclosure can apply to various operations of the networked presentation system without departing from the concepts. The specification and drawings are, accordingly, to be regarded in an illustrative rather than a restrictive sense.

What is claimed is:

1. A method for managing simulation results of a virtual circuit comprising:
accessing description data related to the virtual circuit;
subjecting the virtual circuit to a simulation according simulation code;
automatically identifying an initiation of each of one or more transactions occurring during the simulation;
collecting data related to the one or more transactions during the simulation; and
outputting the collected data related to the one or more transactions.

2. The method of claim 1, wherein the data related to the identified transaction includes at least one of a name of each of the one or more transactions, a start time of each of the one or more transactions, an end time or duration of each of the one or more transactions, a stream corresponding to where each of the one or more transactions takes place, names of variables associated with each of the one or more transactions, error information associated with each of the one or more transactions, and variable values for each named variable associated with each of the one or more transactions.

3. The method of claim 1 further identifying the termination of each of the one or more transactions.

4. The method of claim 1 further graphically displaying a result of the simulation and the data related to each of the one or more transactions in a way that distinct transactions are visually distinguishable.

5. The method of claim 1 further providing a visual indication indicating that detailed information related to the one or more transactions is available.

6. The method of claim 1 further graphically displaying the data related to each of the one or more transactions relative to a time axis.

7. The method of claim 1, wherein the automatically identifying the initiation of each of the one or more transactions further comprises identifying according to at least one of a call to a subprogram and creation of a data object.

8. A machine-readable medium incorporating instructions which, upon execution by a data processing system, control the data processing system to:
access description data related to a virtual circuit;
subject the virtual circuit to a simulation according to simulation code;
automatically identify an initiation of each of one or more transactions occurred during the simulation;
collect data related to the one or more transactions during the simulation; and
output the collected data related to the one or more transactions.

9. The machine-readable medium of claim 8, wherein the data related to the identified transaction includes at least one of a name of each of the one or more transactions, a start time of each of the one or more transactions, an end time or duration of each of the one or more transactions, a stream corresponding to each of the one or more transactions takes place, names of variables associated with each of the one or more transactions, error information associated with each of the one or more transactions, and variable values for each named variable associated with each of the one or more transactions.

10. The machine-readable medium of claim 8, wherein the instructions which, upon execution by the data processing system, further control the data processing system to identify the termination of each of the one or more transactions.

11. The machine-readable medium of claim 8, wherein the instructions which, upon execution by the data processing system, further control the data processing system to graphically display a result of the simulation and the data related to each of the one or more transactions in a way that distinct transactions are visually distinguishable.

12. The machine-readable medium of claim 8, wherein the instructions which, upon execution by the data processing system, further control the data processing system to provide a visual indication indicating that detailed information related to the one or more transactions is available.

13. The machine-readable medium of claim 8, wherein the instructions which, upon execution by the data processing system, further control the data processing system to graphically display the data related to each of the one or more transactions relative to the same time axis.

14. The medium of claim 8, wherein the automatically identifying the initiation of the one or more transactions further comprises identifying according to at least one of a call to a subprogram and creation of a data object.

15. A data processing system for managing simulation results of a virtual circuit, the system comprising:
a data processor configured to process data; and
a data storage medium incorporating instructions which, upon execution by the data processor, control the data processing system to access description data related to a virtual circuit, subject the virtual circuit to a simulation, automatically identify an initiation of each of one or more transactions occurred during the simulation, collect data related to the one or more transactions during the simulation, and output the collected data related to the one or more transactions.

16. The system of claim 15, wherein the data related to the identified transaction includes at least one of a name of each of the one or more transactions, a start time of each of the one or more transactions, an end time or duration of each of the one or more transactions, a stream corresponding to each of the one or more transactions takes place, names of variables associated with each of the one or more transactions, error information associated with each of the one or more transactions, and variable values for each named variable associated with each of the one or more transactions.

17. The system of claim 15, wherein the instructions which, upon execution by the data processor, further control the data processing system to identify the termination of each of the one or more transactions.

18. The system of claim 15, wherein the instructions which, upon execution by the data processor, further control the data processing system to graphically display a result of the simulation and the data related to each of the one or more transactions in a way that distinct transactions are visually distinguishable.

19. The system of claim 15, wherein the instructions which, upon execution by the data processor, further control the data processing system to provide a visual indication indicating that detailed information related to the one or more transactions is available.

20. The system of claim 15, wherein the instructions which, upon execution by the data processor, further control the data processing system to graphically display the data related to each of the one or more transactions relative to the same time axis.
